(19) United States
(12) Patent Application Publication
(10) Pub. No.: US 2008/0300830 A1
(43) Pub. Date: Dec. 4, 2008

(54) DATA RECORDING APPARATUS AND DATA RECORDING METHOD

(75) Inventors: Hisaaki Hatano, Yokohama-Shi (JP); Akihiro Suyama, Tokyo (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/128,758

(22) Filed: May 29, 2008

(30) Foreign Application Priority Data
May 31, 2007 (JP) 2007-144695

(51) Int. Cl. G06F 19/00

(52) U.S. Cl. 702/189

(57) ABSTRACT

There is provided with a data recording apparatus including: an observed data storage configured to store values observed by a sensor in association with an observed time; an intersection processing unit configured to plot each observed value in the observed data storage on a plane coordinate system formed by a time axis and an axis representing a value of the sensor, configured to determine whether or not a line segment connecting between observed values at adjacent times intersects a base line preset on the plane coordinate system and configured to calculate an intersection time of the line segment and the base line when the line segment intersects the base line; an intersection data storage configured to store the intersection time calculated by the intersection processing unit; and a deleting unit configured to delete observed values subjected to a processing of the intersection processing unit from the observed data storage.

### CROSS REFERENCE TO RELATED APPLICATIONS

This application is based upon and claims the benefit of priority from the prior Japanese Patent Applications No. 2007-144695, filed on May 31, 2007; the entire contents of which are incorporated herein by reference.

### BACKGROUND OF THE INVENTION

1. Field of the Invention

The present invention relates to a data recording apparatus and a data recording method, and a computer readable medium.

2. Related Art

Advances of sensors and networks have made it possible to collect a huge amount of data but it is not realistic to record all of such data. For example, when devices are remotely monitored for proper operation, communication costs for centrally collecting all data significantly increases as the number of devices increases. Also, it is often difficult to provide mass-data storages in devices because of limits of power consumption, weight, and size. Therefore, there is a need for a technique that reduces the amount of data to collect in order to keep communication traffic within certain limits or to effectively use storage areas having limited capacities.

There have been proposed methods, including a method in which data is collected at shorter sampling intervals just before and after a device sends a fault signal (U.S. Pat. No. 6,947,797) and a method in which data is recorded on the basis of predetermined criteria such as a variation rate of a sensor signal in a day that is equal to or more than 20%(U.S. 2004/0010374A1). However, with these methods, it is obviously impossible to cause a device to send a fault signal or to set criteria beforehand unless the monitoring device has prior knowledge of behavior exhibited by devices when they are malfunctioning.

A technique has been proposed in which a time-series signal is sampled at a sampling rate that is lowered to the minimum extent necessary to approximate the time-series signal by piecewise linear approximation (U.S. Pat. No. 7,076,402). However, this technique has a poor capability of approximating signals such as oscillating waveforms that cannot be approximated by collinear approximation.

### SUMMARY OF THE INVENTION

According to an aspect of the present invention, there is provided with a data recording apparatus comprising:
an observed data storage configured to sequentially store a value observed by a sensor in association with an observed time;
an intersection processing unit
   configured to plot each observed value in the observed data storage on a plane coordinate system formed by a time axis and an axis representing a value of the sensor,
   configured to determine whether or not a line segment connecting between observed values at adjacent times intersects a base line preset on the plane coordinate system and
   configured to calculate an intersection time of the line segment and the base line when the line segment intersects the base line;
an intersection data storage configured to store the intersection time calculated by the intersection processing unit; and
a deleting unit configured to delete observed values subjected to a processing of the intersection processing unit from the observed data storage.

According to an aspect of the present invention, there is provided with a data recording apparatus comprising:
an observed data storage configured to sequentially store a value observed by a sensor in association with an observed time;
a base line/auxiliary line storage configured to store a base line set on a plane coordinate system formed by a time axis and an axis representing a value of the sensor and first and second auxiliary lines provided on opposite sides with respect to the base line along the base line;
an intersection processing unit
   configured to plot each observed value in the observed data storage on the plane coordinate system,
   configured to determine whether or not a line segment connecting between observed values at adjacent times intersects the first or second auxiliary line, and
   configured to specify one of two end points of the line segment, that belongs to a base region formed between the first and second auxiliary lines when the line segment intersects the first or second auxiliary line;
an intersection data storage configured to store the point specified by the intersection processing unit; and
a deleting unit configured to delete observed values subjected to a processing of the intersection processing unit from the observed data storage.

According to an aspect of the present invention, there is provided with a data recording apparatus, comprising:
an observed data storage configured to sequentially store data including values observed by a plurality of sensors in association with an observed time;
an intersection processing unit
   configured to plot each data in the observed data storage on a space coordinate system formed by a time axis and axes representing values of the sensors
   configured to determine whether or not a line segment connecting between each data at adjacent times intersects a base plane preset on the space coordinate system and
   configured to calculate a intersection point of the line segment and the base plane when the line segment intersects the base plane;
an intersection data storage configured to store an intersection point calculated by the intersection processing unit; and
a deleting unit configured to delete data subjected to a processing of the intersection processing unit from the observed data storage.

According to an aspect of the present invention, there is provided with a data recording method comprising:
sequentially recording a value observed by a sensor in association with an observed time in an observed data storage;
plotting each observed value in the observed data storage on a plane coordinate system formed by a time axis and an axis representing a value of the sensor,
determining whether or not a line segment connecting between observed values at adjacent times intersects a base line preset on the plane coordinate system and
calculating an intersection time of the line segment and the base line when the line segment intersects the base line;
recording calculated intersection time in intersection data storage; and
deleting observed values subjected to a processing of the determining or the calculating from the observed data storage.

According to an aspect of the present invention, there is provided with a data recording method comprising:
sequentially recording a value observed by a sensor in association with an observed time in an observed data storage;
setting a base line on a plane coordinate system formed by a time axis and an axis representing a value of the sensor and first and second auxiliary lines on opposite sides with respect to the base line along the base line;
plotting each observed value in the observed data storage on the plane coordinate system,
determining whether or not a line segment connecting between observed values at adjacent times intersects the first or second auxiliary line, and
specifying one of two end points of the line segment, that belongs to a base region formed between the first and second auxiliary lines when the line segment intersects the first or second auxiliary line;
recording a specified point in an intersection data storage; and
deleting observed values subjected to a processing of the determining or the specifying from the observed data storage.

According to an aspect of the present invention, there is provided with a data recording method, comprising:
sequentially recording data including values observed by a plurality of sensors in association with an observed time in an observed data storage;
plotting each data in the observed data storage on a space coordinate system formed by a time axis and axes representing values of the sensors
determining whether or not a line segment connecting between each data at adjacent times intersects a base plane preset on the space coordinate system and
calculating a intersection point of the line segment and the base plane when the line segment intersects the base plane;
recording a calculated intersection point in an intersection data storage; and
deleting data subjected to a processing of the determining or the calculating from the observed data storage.

### BRIEF DESCRIPTION OF THE DRAWINGS

FIG. 1 is a block diagram showing a configuration of a data reduction apparatus as a first embodiment of the present invention;

FIG. 2 is a diagram showing an example in which three points of intersection with a base line that are extracted from an observed varying signal;

FIG. 3 is a flowchart showing one exemplary flow of a process performed by the data reduction apparatus shown in FIG. 1;

FIG. 4 is a flowchart showing a detailed flow for determining whether there is an intersection;

FIG. 5 is a diagram illustrating how an intersection point of a line and a base line is obtained;

FIG. 6 is a diagram illustrating how observation points on a base line are treated;

FIG. 7 is a block diagram showing a configuration of a data reduction apparatus as a second embodiment of the present invention;

FIG. 8 is a flowchart illustrating an exemplary flow of a process performed by the data reduction apparatus shown in FIG. 7;

FIG. 9 is a flowchart showing an exemplary flow of calculation of a base line;

FIG. 10 is a diagram showing observation points recorded when a base line is changed;

FIG. 11 is a block diagram showing a configuration of a data reduction apparatus as a third embodiment of the present invention;

FIG. 12 is a diagram illustrating a subject matter of the third embodiment;

FIG. 13 is a flowchart showing an exemplary flow of a process performed by the data reduction apparatus shown in FIG. 11;

FIG. 14 is a diagram illustrating a subject matter of a fourth embodiment;

FIG. 15 is a flowchart showing an exemplary flow of a process according to the fourth embodiment;

FIG. 16 is a block diagram showing a configuration of a data reduction apparatus as a fifth embodiment;

FIG. 17 is a diagram showing data plotted in a three-dimensional space formed by three axes, that is, axis of two sensors and a time axis;

FIG. 18 is a diagram showing an example in which a data reduction apparatus according to the present invention is applied to remote monitoring of devices;

FIG. 19 is a diagram showing an exemplary application of a data reduction apparatus according to the present invention;

FIG. 20 is a diagram showing that a given sequence of points can be smoothly connected by a spline curve;

FIG. 21 is a diagram showing a restoration method for a case where there is a single base line and only the signs of the slopes at intersection points are known;

FIG. 22 is a diagram showing an example of a restoration method for a case where the base line in FIG. 21 is oblique;

FIG. 23 is a diagram showing an example of a restoration method for a case where there is a single base line and the slopes at intersection points are known;

FIG. 24 is a diagram showing a restoration method for a case where there are multiple parallel base lines;

FIG. 25 is a diagram illustrating an example of a process performed when there is a contradiction between a calculated peak point and intersection point information;

FIG. 26 is a diagram showing an exemplary procedure for calculating peak points required for drawing a spline curve from three base lines and intersection points on them;

FIG. 27 is a diagram showing one example of a database generated by data reduction shown in the first or fourth embodiment;

FIG. 28 is a flowchart showing a procedure flow for restoration; and

FIG. 29 is a flowchart showing a flow of a peak point calculation routine.

### DETAILED DESCRIPTION OF THE INVENTION

### First Embodiment

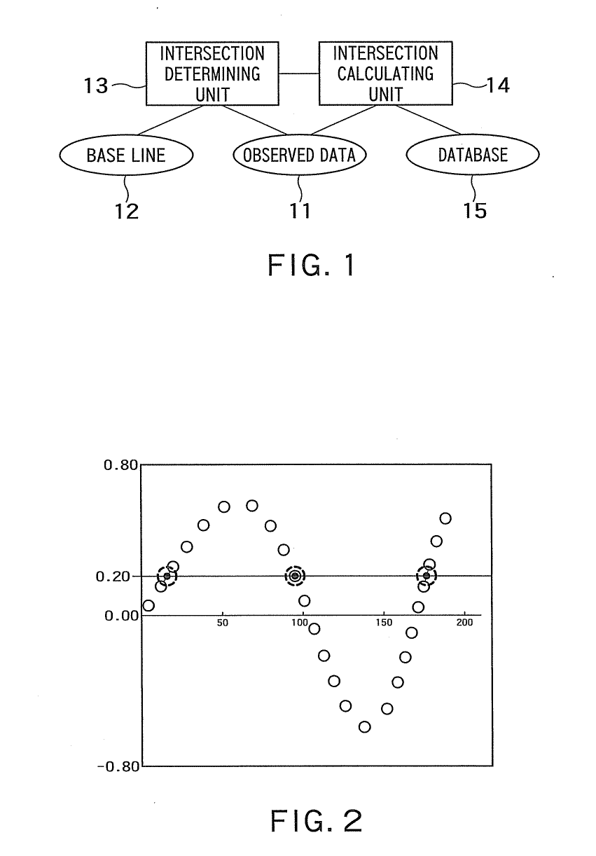

FIG. 1 is a block diagram showing a configuration of data reduction apparatus (data recording apparatus) as a first embodiment of the present invention.

The data reduction apparatus is characterized in that a base line is provided beforehand and intersection points (or intersection times) of time-series data observed by a sensor and the base line are recorded. FIG. 2 shows an example in which three points of intersection with a base line are extracted from an observed varying signal, where the base line is at x=0.2, the vertical axis represents “x”, and the horizontal axis represents time “t”. Intersection times may be recorded instead of intersection points. In that case, a value of “x” can be calculated from an intersection time and the base line. The data reduction apparatus will be described below in detail.

An observed data recording unit (an observed data storage) 11 in FIG. 1 chronologically records observed values obtained by a sensor observing a device. That is, the observed data recording unit 11 records observed time-series data.

A base line storage 12 stores a base line used for determining intersection with observed time-series data.

An intersection determining unit 13 determines whether a line segment that connects observed values at adjacent times of observed time-series data intersects the base line.

An intersection calculating unit 14, if the intersection determining unit 13 determines that the line segment intersects the base line, calculates an intersection point (or intersection time) of the line segment and the base line and the sign of the slope (slope information) at the intersection point. Instead of the sign of the slope, the slope (an increase or decrease) at the intersection may be calculated as the slope information. The slope can be calculated by the following equation:

$$Slope = \frac{{x}_{2} - {x}_{1}}{{t}_{2} - {t}_{1}} \qquad [ Formula 1 ]$$

where (x1, t1) and (x2, t2) are observed values at adjacent times.

A database (intersection data storage) 15 records an intersection point (or intersection time) and slope information calculated by the intersection calculating unit 14.

The set of the intersection determining unit 13 and the intersection calculating unit 14 described above represents an intersection processing unit, for example. The data reduction apparatus in FIG. 1 may further include a data deleting unit that deletes data that is no longer necessary (for example observed values processed by the intersection processing unit). The data reduction apparatus may further include a data transmitter that transmits intersection points (or intersection times and the base line) and slope information recorded in the database 15 over a network.

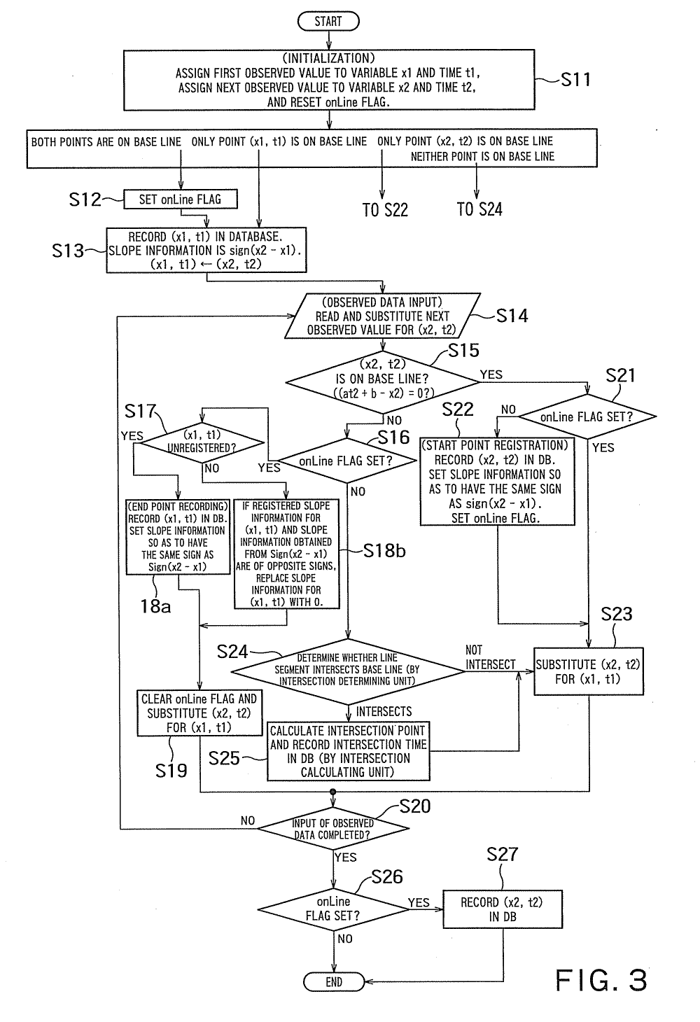

FIG. 3 is a flowchart showing an exemplary flow of a process performed by the data reduction apparatus shown in FIG. 1. The process may be performed by causing a computer to execute a program in which instruction codes are written that instructs the computer to execute the steps shown in the flowchart. The program may be stored in a computer readable medium like CD-ROM, Hard disk-drive, CD-R and a memory stick.

At S11, initialization is performed. The first observed value and time are substituted for an observed value x1 at the previous time and the previous time t1 and the next observed value and time are substituted for a variable x2 representing an observed value at the current time and the current time t2. An onLine flag (online flag) is reset. Then, determination is made as to whether the two points (x1, t1) and (x2, t2) are on a base line. If both are on the base line, the process proceeds to S12; if only (x1, t1) is on the base line, the process proceeds to S13; if only (x2, t2) is on the base line, the process proceeds to S22; and if neither of them is on the base line, the process proceeds to S24.

At S12, the online flag is set. The online flag indicates whether or not an observed value at the current time (here, (x2, t2)) is on the base line (x=at+b). When the online flag is set, it indicates that the observed value is on the base line; when the online flag is cleared, it indicates that the observed value is not on the base line.

At S13, (x1, t1) and slope information are recorded in the database 15. The slope information is calculated by sign(x2−x1). When x<0, sign(x) is −1 (negative); when x=0, sign(x) is 0; and when x>0, sign(x) is 1 (positive). After being recorded in the database 15, (x2, t2) is substituted for (x1, t1).

At S14, the next observed value is read and substituted for (x2, t2).

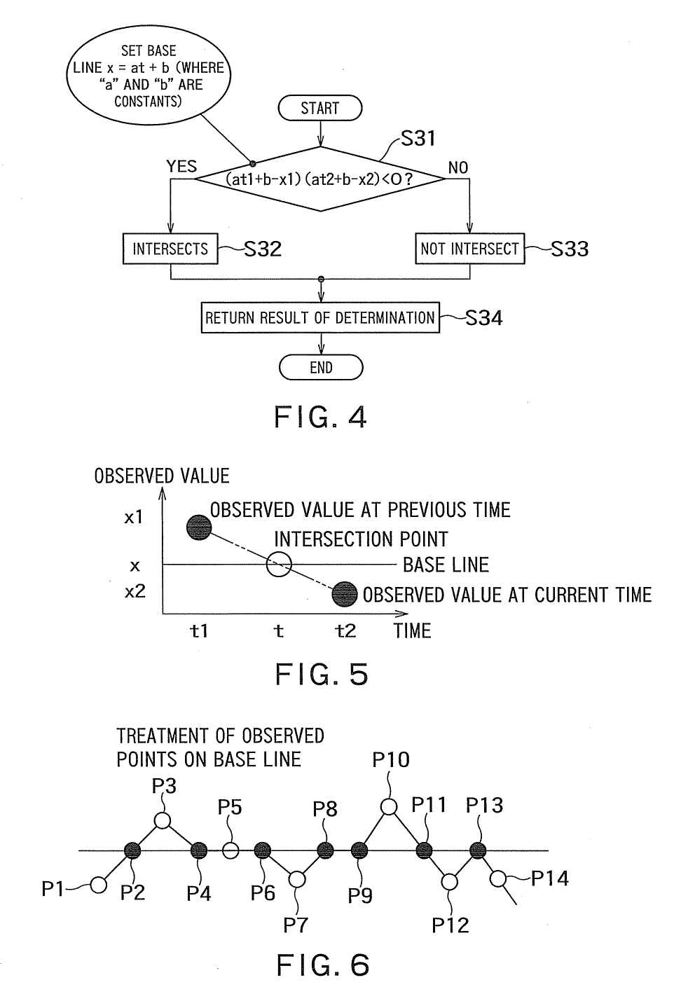

If (x2, t2) is not on the base line and (determination at S15 is NO) and the online flag is not set ((x1, t1) is not on the base line) (determination at S16 is NO), then determination is made as to whether the line segment connecting (x2, t2) and (x1, t1) intersects the base line (S24). FIG. 4 shows a detailed flow for determining whether or not the line segment intersects the base line.

Determination is made as to whether (at1+b−x1) (at2+b−x2)<0 is satisfied (S31) when the base line is x=at+b. If satisfied, it is determined that the line segment intersects the base line (S32); otherwise, it is determined that the line segment does not intersect the base line (S33). The result of the determination (whether it intersects or not) is returned (S34).

If the result of the determination is “Intersects”, the intersection point of the line segment and the base line is calculated, and the obtained calculated intersection point and slope information “sign(x2−x1)” are recorded in the database 15 (S25). FIG. 5 shows how the intersection point is calculated. The intersection time at the intersection point can be obtained by the formula below.

$$t = \frac{( {t}_{2} - {t}_{1} ) ( b - {x}_{1} ) + {t}_{1} ( {x}_{2} - {x}_{1} )}{( {x}_{2} - {x}_{1} ) - a ( {t}_{2} - {t}_{1} )} \qquad [ Formula 2 ]$$

The value of “x” at the intersection point can be calculated from the intersection time and the base line. After the intersection point and slope information are recorded in the database 15 or the result of the determination is “Not intersect”, (x2, t2) is substituted for (x1, t1) (S23) and the process proceeds to S20.

At S20, determination is made as to whether there is additional observed data (S20). If there is additional observed data (determination at S20 is NO), the process returns to S14, where the next observed value is read and substituted for (x2, t2).

If it is determined at S15 that (x2, t2 ) is on the base line (determination at S15 is YES) and the online flag is set ((x1, t1) is on the base line) (determination at S21 is YES), then (x2, t2) is substituted for (x1, t2) without performing anything (S23). This represents a process for omitting recording of intermediate values as part of a process in which, if successive observed values are on the base line, recording of the value or values (intermediate values) between the first and last observed values on the base line is omitted and only the first and last observed values are recorded. The process will be described specifically with reference to FIG. 6. Three successive observed values P4, P5, and P6 are on the base line. In this case, P5, which is at the midpoint between the start and end points is not recorded to minimize the amount of data to store. The black dots in FIG. 6 represent intersection points to be recorded in the database.

If (x2, t2) is on the base line (determination at S15 is YES) but the online flag is not set ((x1, t1) is not on the base line) (determination at S21 is NO), then (x2, t2) and slope information “sign(x2−x1)” are recorded in the database 15. This represents a process for recoding observed value (x2, t2) located on the base line (for example a process for recording P2 in FIG. 6). Then the online flag is set (S22) and (x2, t2) is substituted for (x1, t1) (S23). If there is additional observed data (determination at S20 is NO), the process returns to S14, where the next observed value is read and substituted for (x2, t2).

If (x2, t2) is not on the base line (determination at S15 is NO) and the online flag is set ((x1, t1) is on the base line) (determination at S16 is YES), then the database 15 is checked to see whether (x1, t1) has been already registered in the database 15 (S17). If it has not yet been registered (YES), (x1, t1) and slope information “sign(x2−x1)” are registered (S18a). This represents a process in which the last observed value (which is (x1, t1)) is recorded when successive observed values are on the base line (the process for recording P6 in FIG. 6). Then, the online flag is cleared and (x2, t2) is substituted for (x1, t1) (S19). If there is additional observed data (determination at S20 is NO), the process returns to S14, where the next observed value is read and substituted for (x2, t2).

On the other hand, if (x1, t1) has already been registered (determination at S17 is NO) and slope information at (x1, t1) differs from slope information obtained from sign(x2−x1), the slope information at (x1, t1) is replaced with 0 (S18b). This represents a process in which the slope of an observed value on the base line is replaced with 0 when the observed value comes from a direction (for example from below the base line) is positioned on the base line and returns in the same direction, like P13 in FIG. 6. Then, the online flag is cleared and (x2, t2) is substituted for (x1, t1) (S19). If there is additional observed data (determination at S20 is NO), the process returns to S14, where the next observed value is read and substituted for (x2, t2).

If there is not additional observed data at S20 (determination at S20 is YES) and the online flag is set (determination at S26 is YES), (x2, t2) is registered in the database 15 (S27) and then the process will end. If the online flag is not set (determination at S26 is NO), the process will immediately end.

As has been described above, according to the present embodiment, when a line segment that connects observed values at adjacent times intersects a base line, the intersection point of the line segment and the base line (or intersection times) is calculated and the calculated intersection point (or intersection time) is recorded. By transmitting data on the intersection points (or intersection times) thus recorded is transmitted to the analysis center apparatus, traffic on the network between the data recording apparatus and a analysis center apparatus, for example, can be reduced as compared with a case where observed data is transmitted in a conventional manner. Furthermore, only intersection points (or intersection times), which have a small amount of data, need to be stored, storage consumption can be reduced. In addition, even observed time-series data that exhibits a waveform signal can be restored with a high degree of accuracy as will be illustrated by a seventh embodiment described later. The effects of the present embodiment are also exerted in other embodiments which will be described later.

### Second Embodiment

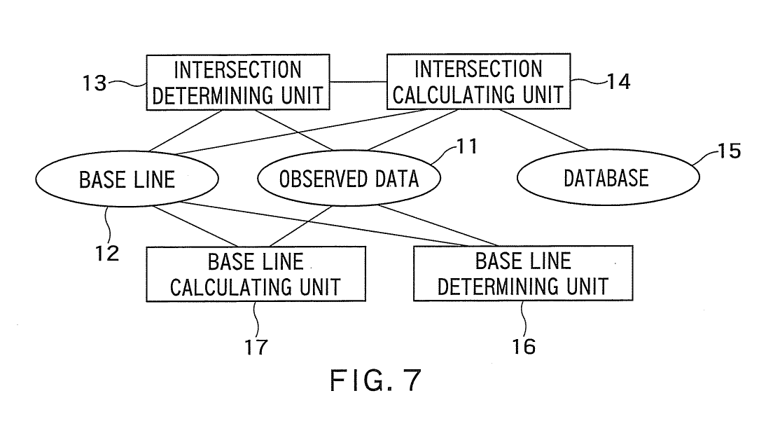

FIG. 7 is a block diagram showing a configuration of a data reduction apparatus (data recording apparatus) as a second embodiment of the present invention. The data reduction apparatus includes, in addition to the components of the data reduction apparatus in FIG. 1, a base line determining unit 16 that determines whether a base line is appropriate or not on the basis of observed data and a base line calculating unit 17 that calculates a new base line from observed data when the base line determining unit 16 determines that a base line is inappropriate.

The base line determining unit 16 determines whether a base line is appropriate or not when a predetermined criterion is met, for example when a predetermined time interval has elapsed or a predetermined number of observed values is reached. If the base line determining unit 16 determines that a base line is inappropriate, the base line determining unit decides to calculate a new base line. For example, if the error between data x(t) observed at the current time and “at+b” calculated on the base line is greater than or equal to a constant multiple of the standard deviation of residual errors calculated by base line calculation processing, which will be described later (|x(t)−(at+b)|>kσ, where k is a predetermined constant), the base line determining unit 16 determines that the base line is inappropriate. Alternatively, the base line determining unit 16 may determine that a base line is inappropriate and decide to calculate a new base line whenever a predetermined time interval has expired or a predetermined number of observed values is reached.

The base line calculating unit 17 calculates a new base line when the base line determining unit 16 determines that a base line is inappropriate. The base line may be a straight line parallel to a time axis that matches the mean value of observed data, for example (which is equivalent to fixing a=0 in x=at+b). Alternatively, the base line may be a straight line x=at+b in general position that is not parallel to a time axis. If a straight line in general position is used, the factor “b” may be chosen such that end points of old and new line segments are connected with each other. For example, suppose that a line segment before change is x=a₁t+b₁ and is changed to x=at+b at time t₀. Because the two straight lines will be connected when values of the straight lines at t=t₀ are made identical, the new straight line is set to x=at+(b₁+a₁t₀−at₀) and parameter “a” is estimated by the least-square method. If intersection times are recorded in the database 15, the base line calculating unit 17 records a history of base line changes and change times inside the base line calculating unit 17 or in the database 15 so that which intersection time is associated with which baseline can be identified. FIG. 10 shows how a base line is changed: base line 1→base line 2→base line 3. The black dots on the base lines represent intersection points recorded in the database and only the observed values at the start and end points of successive observed values observed on the base lines are recorded as in the first embodiment.

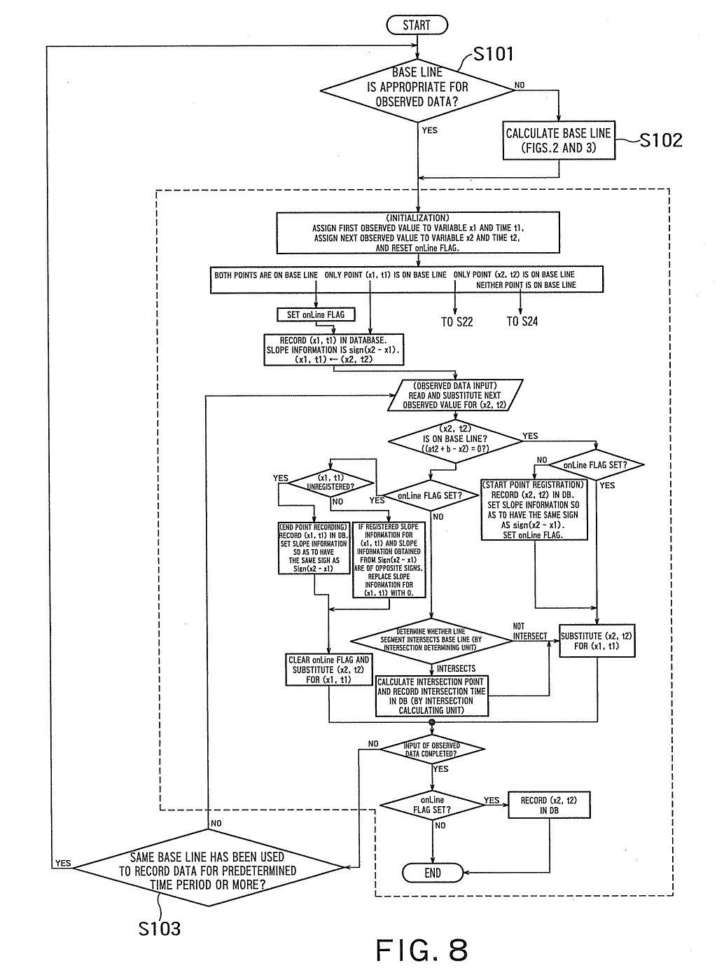

FIG. 8 is a flowchart illustrating an exemplary flow of a process performed by the data reduction apparatus shown in FIG. 7. The process may be performed by causing a computer to execute a program in which instruction codes are written that instruct the computer to execute the steps shown in the flowchart.

The process is basically the same as that in the first embodiment (FIG. 3), except that the step of determining whether or not a base line should be reevaluated (whether or not determination should be made as to whether a base line is appropriate), the step of determining whether the base line is appropriate if it is determined that the base line should be reevaluated, and the step of calculating a new base line if the base line is inappropriate are added. The steps in the dashed box in FIG. 8 are the same steps as those in the first embodiment. Therefore differences from the first embodiment will be described below.

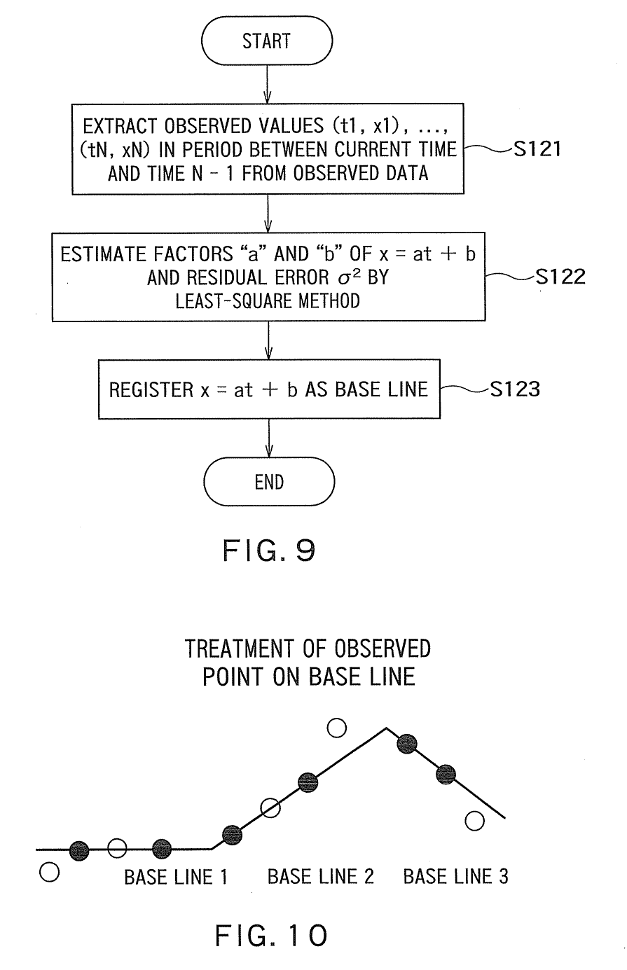

Determination is made at S101 as to whether a base line is appropriate. If not (NO), a new base line is calculated. FIG. 9 shows an exemplary flow of calculation of a base line.

Observed values in the period from the current time to time N−1 are extracted from observed data (S121) and factors “a” and “b” in x=at+b and a residual error σ² are estimated by the least-square method (S122). The estimated x=at+b is registered as a base line (S123).

The base line is used to perform the same process as that in the first embodiment and each time it is determined that there is additional observed data (determination at S20 is NO), determination is made as to whether the same base line has been used to record data in a predetermined time period or more (S103). If the time period over which the same base line has been used does not longer than or equal to the predetermined time period (determination at S103 is NO), it is determined that the base line does not need to be reevaluated and the process returns to S14, where the next observed value is read. On the other hand, if the same base line has been used during the predetermined time period or more (determination at S103 is YES), the process returns to S101, where determination is made as to whether the base line is appropriate.

As has been described above, according to the present embodiment, whether a base line is appropriate or not is determined as needed and, if the base line is inappropriate, the base line is changed. Accordingly, the accuracy of restoration of sensor data can be improved.

### Third Embodiment

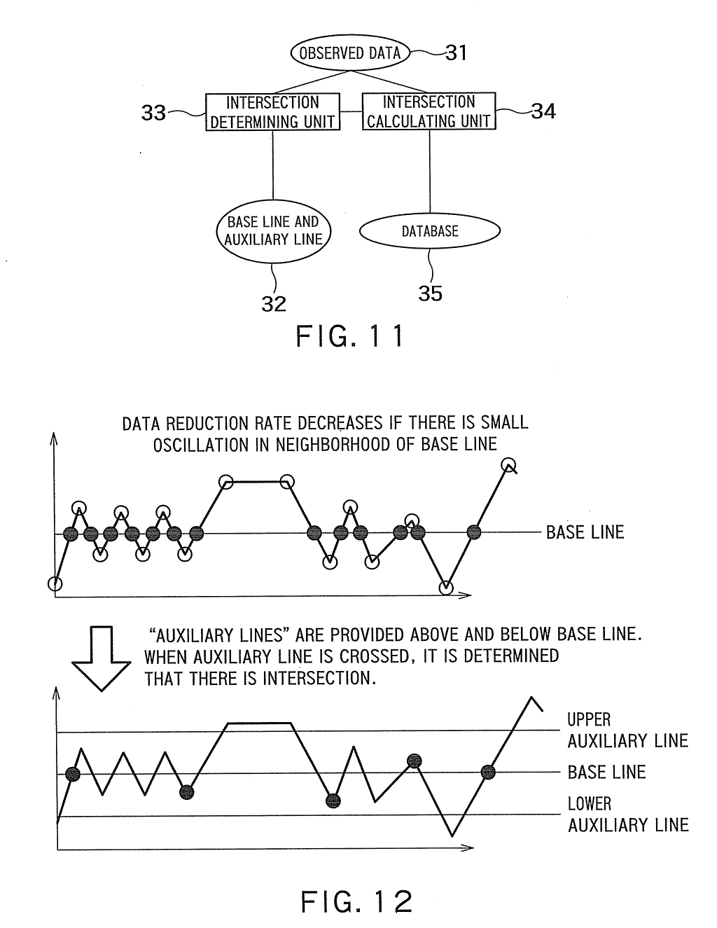

FIG. 11 is a block diagram showing a configuration of a data reduction apparatus (data recording apparatus) as a third embodiment of the present invention.

An observed data recording unit (an observed data storage) 31 chronologically records observed values obtained by a sensor that observes a device.

A base line/auxiliary line storage 32 stores a base line and two auxiliary lines parallel to the base line. The two auxiliary lines are an upper auxiliary line and a lower auxiliary line. The region above the upper auxiliary line is assumed as the upper non-base region, the area below the lower auxiliary line is assumed as lower non-base region, and the region between the upper and lower auxiliary lines is assumed as the base region.

An intersection determining unit 33 determines whether a line segment that connects observed values at adjacent times intersects the base region. In particular, the intersection determining unit 33 determines whether the line segment intersects the upper or lower auxiliary line (that is, an observed value enters or exits the base region). If the line intersects the upper or lower auxiliary line, the intersection determining unit 33 determines that the line intersects the base region.

An intersection calculating unit 34 calculates the intersection point of the line segment and the base region (an observed value immediately after entering the base region or an observed value immediately before exiting the base region) and the sign of the slope (slope information) at the intersection point if the intersection determining unit 13 determined that the line segment intersects the base region. Instead of the sign of the slope, the slope (an increase or decrease) may be calculated.

A database 35 records the intersection point and slope information calculated by the intersection calculating unit 14.

The set of the intersection determining unit 33 and the intersection calculating unit 34 represents an intersection processing unit, for example. The data reduction apparatus in FIG. 11 may further include a data deleting unit that deletes data that is no longer necessary (for example observed values processed by the intersection processing unit). The data reduction apparatus may further include a data transmitter that transmits intersection points and slope information recorded in the database 35 over a network. The data transmitter may also transmit data on the base line and upper and lower auxiliary lines.

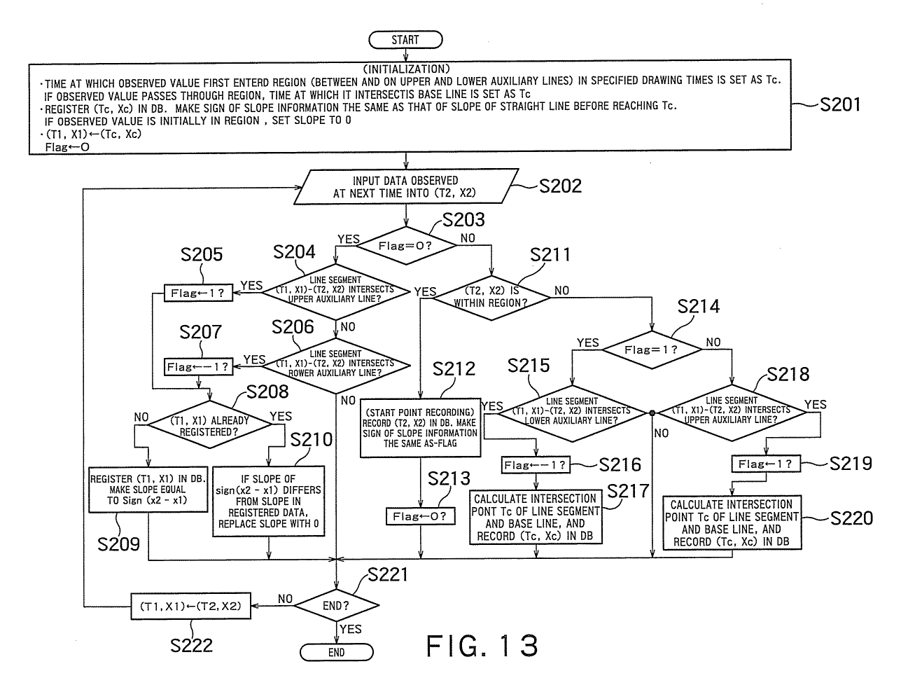

When an observed value enters or exits the base region between the two auxiliary lines, it is determined that an intersection with the base region has occurred (the line segment is considered to intersect the base line) in the present embodiment. This can significantly reduce the amount of data to be stored when a small oscillation occurs in a neighborhood of the base line. That is, the amount of date to be stored increases when a small oscillation occurs in a neighborhood of the base line in the first embodiment because all data about points of intersection with the base line are recorded as shown in the upper part of FIG. 12 in the first embodiment. In the present embodiment, in contrast, the amount of data to be stored can be minimized even when a small oscillation occurs in a neighborhood of the base line, because auxiliary lines are provided above and below the base line as shown in the lower part of FIG. 12 and data is stored based on whether or not observed values intersect the base region between the auxiliary lines (whether observed values enter or exit the base region).

FIG. 13 is a flowchart showing an exemplary flow of a process performed by the data reduction apparatus shown in FIG. 11. The process may be performed by causing a computer to execute a program in which instruction codes are written that instruct the computer to execute the steps shown in the flowchart.

In this process, an observed value immediately after entering the base region and slope information and an observed value immediately before exiting the base region and slope information are recorded. When a line segment passes through the base region from the upper non-base region to the lower non-base region or in the direction opposite to this, the intersection point (or intersection time) of the line segment and the base line and slope information are recorded. This process will be described below in detail.

Initialization is performed at S201. The first observed value that entered the base region (including the auxiliary lines) is represented by (Tc, Xc). However, if the observed value passes through the base region, the intersection with the base line is represented by (Tc, Xc). The sign of the slope information of (Tc, Xc) is made the same as the sign of the slope between (Tc, Xc) and the previous observed value. If the observed value is initially in the base region, the slope information is 0. (Tc, Xc) and the slope information are recorded in the database 35. Then, (Tc, Xc) is substituted for (T1, X1) and 0 is substituted for “Flag”. “Flag” takes one of three values, 1, 0, and −1, where 1 indicates that the observed value is in the upper non-base region, 0 indicates that the observed value is in the base region, and −1 indicates that the observed value is in the lower non-base region.

After completion of the initialization, an observed value at the next time is input in (T2, X2) at S202. Then, determination is made as to whether “Flag” is 0 (S203).

If “Flag” is 0 (determination at S203 is YES) and the line segment between (T1, X1) and (T2, X2) intersects neither of the upper and lower auxiliary lines (determinations at S204 and S206 are NO), nothing is done. That is, because the change between (T1, X1) and (T2, X2) is a change within the base region, they are not recorded in the database 35. If there is additional observed data (determination at S221 is NO), then (T2, X2) is input in (T1, X1) (S222), then the process returns to S202, where the next observed value is read.

If “Flag” is 0 (determination at S203 is YES) and the line segment between (T1, X1) and (T2, X2) intersects the upper auxiliary line (determination at S204 is YES), 1 is assigned to “Flag” (because (T2, X2) is in the upper non-base region). On the other hand, if “Flag” is 0 (determination at S203 is YES) and the line segment between (T1, X1) and (T2, X2) intersects the lower non-base region (determination at S206 is YES), −1 is assigned to “Flag” (because (T2, X2) is in the lower non-base region). After 1 or −1 is assigned to “Flag”, and if (T1, X1) has not yet been recorded (determination at S208 is NO), then (T1, X1) and slope information sign(x2−x1) are recorded in the database 35 (S209). If (T1, X1) has already been recorded (determination at S208 is YES) and the slope information for the recorded (T1, X1) and sign(x2−x1) are different, then the slope information for the recorded (T1, X1) is replaced with 0. This replacement corresponds to processing in which, if an observed value enters the base region from a certain direction (for example from the lower non-base region) and returns to the same direction (to the lower non-base region) without passing through to the upper non-base region, the slope of the observed value, immediately before the value returns, is set to 0. If there is additional observed data (determination at S221 is NO), then (T2, X2) is input in (T1, X1) (S222), and then the process returns to S202, where the next observed value is read.

If “Flag” is not 0 (determination at S203 is NO), that is, if “Flag” is 1 or −1, then determination is made as to whether (T2, X2) is in the base region (S211).

If (T2, X2) is in the base region (determination at S211 is YES), then (T2, X2) is an observed value that has just entered the base region and therefore (T2, X2) and slope information are recorded in the database 35. The slope information is set as “− Flag”. That is, when an observed value enters the base region from the upper non-base region, the slope information is set to −1; when an observed value enters the base region from the lower non-base region, the slope information is set to 1. Of course, the slope information may be calculated as sign(x2−x1). Then, 0 is assigned to “Flag” (S213). If there is additional observed data (determination at S221 is NO), (T2, X2) is input in (T1, X1) (S222), and then process returns to S202, where the next observed value is read.

If (T2, X2) is not in the base region (determination at S211 is NO), the next step depends on whether “Flag” is 1 or −1.

When “Flag” is 1 (determination at S214 is YES), examination is performed to determine whether the line segment between (T1, X1) and (T2, X2) intersects the lower auxiliary line (S215). If the line segment intersects (YES), that is, the line segment passes through from the upper non-base region to the lower non-base region, −1 is assigned to “Flag” (S216), the intersection point of the line segment and the base line is calculated as (Tc, Xc) and recorded in the database 35 (S217). If the line segment does not intersect the lower non-base region (determination at S215 is NO), that is, (T2, X2) remains in the upper non-base region, nothing is done (“Flag” is kept 1). Then, if there is additional observed data (determination at S221 is NO), (T2, X2) is input in (T1, X1) (S222), then the process returns to S202, where the next observed value is read.

When “Flag” is −1 (determination at S214 is NO), examination is performed to determine whether the line segment between (T1, X1) and (T2, X2) intersects the upper auxiliary line (S218). If it intersects (YES), that is, the line segment passes through from the lower non-base region to the upper non-base region, 1 is assigned to “Flag” (S219) and the intersection point of the line segment and the base line is calculated as (Tc, Xc) and recorded in the database 35 (S220). If the line segment does not intersect the upper auxiliary line (determination at S218 is NO), that is, (T2, X2) remains in the lower non-base region, nothing is done (“Flag” is kept −1). If there is additional observed data (determination at S221 is NO), (T2, X2) is input in (T1, X1) (S222), and the process returns to S202, where the next observed value is read.

### Fourth Embodiment

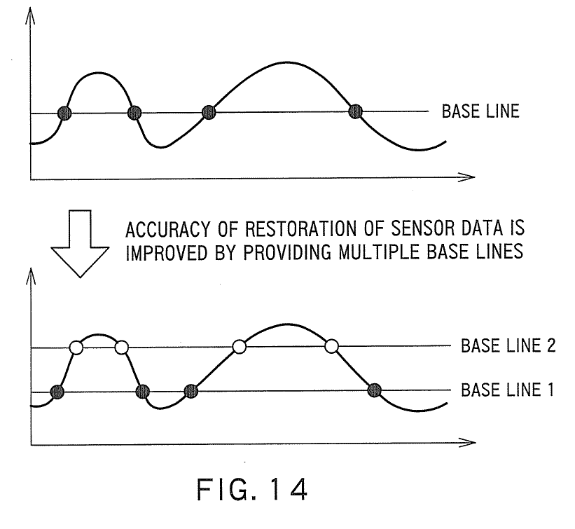

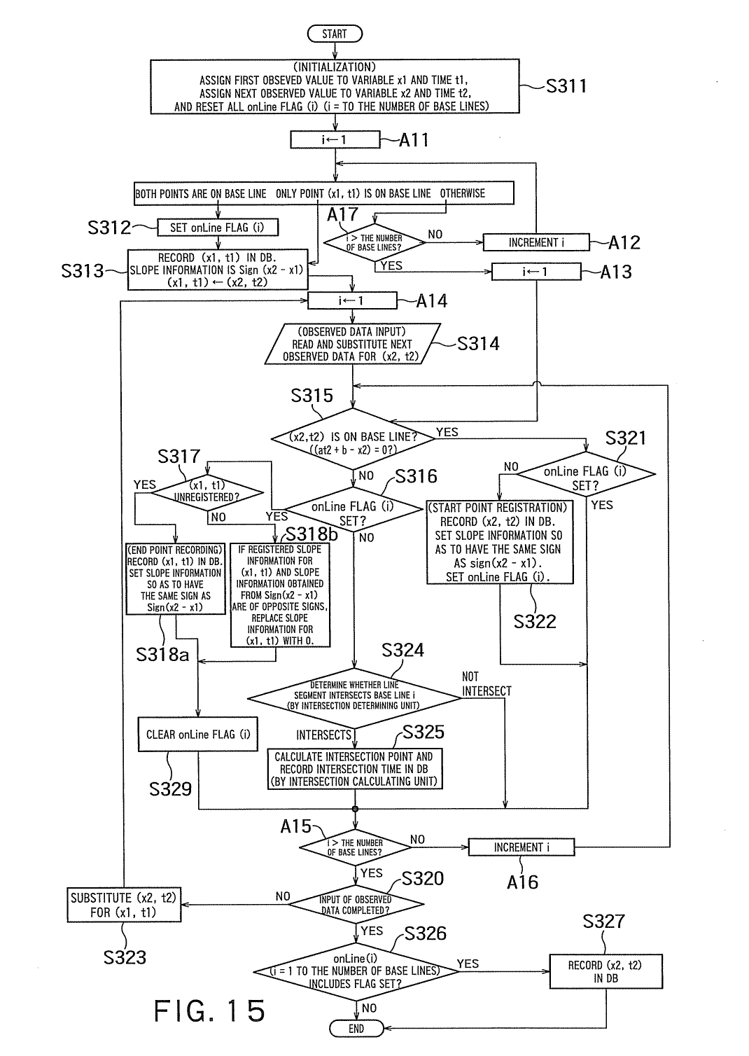

A fourth embodiment is characterized in that multiple base lines are provided in the first to third embodiments. While in the first embodiment a single base line is provided and intersection points with the single base line are obtained as shown in the upper part of FIG. 14, multiple base lines are provided in the fourth embodiment and intersection points with each of the base lines are obtained as shown in the lower part of FIG. 14.

FIG. 15 is a flowchart showing an exemplary flow of a process according to the fourth embodiment. The process may be performed by causing a computer to execute a program in which instruction codes are written that instruct the computer to execute the steps shown in the flowchart. The process is basically equivalent to an implementation in which the process described with respect to the first embodiment is performed for each of the multiple base lines. Therefore details of the process will be apparent from the description of the first embodiment and detailed description will be omitted.

A predetermined number (N) of pieces of observed data are collected and multiple base lines are determined on the basis of a straight line x=at+b obtained from the pieces of data by the least-square method.

For example, if two base lines are to be provided, the standard deviation “σ” of residual errors of N pieces of data with respect to the straight line x=at+b may be used and two base lines

x=at+b+/−σ

may be used.

If three base lines are to be provided,

x=at+b

may be used in addition to the two base lines given above.

If 2m+1 base lines are to be provided,

x=at+b, x=at+b+/−kσ

(where k=1, 2, . . . , m) may be used.

Alternatively, base lines may be chosen on the basis of the number of intersection points for N pieces of data. The multiple base lines do not need to be parallel to each other.

### Fifth Embodiment

A fifth embodiment is characterized in that if observed data is high-dimensional data obtained from multiple sensors in any of the first to fourth embodiments, intersection points with a base plane are recorded.

The fifth embodiment will be described below with respect to the second embodiment extended to have two sensors.

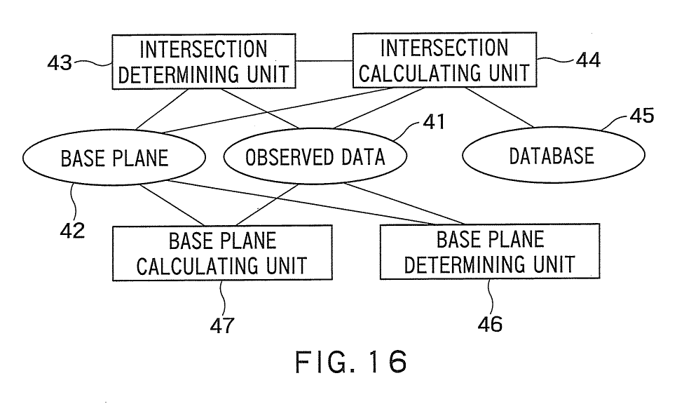

FIG. 16 is a block diagram showing a configuration of a data reduction apparatus (data recording apparatus) as the fifth embodiment.

The data reduction apparatus includes an observed data recording unit (an observed data storage) 41 chronologically recording observed values observed by sensors 1 and 2 that observe devices, a base plane storage 42 storing a base plane, a intersection determining unit 43 that determines whether a line segment that connects observed values at adjacent times in observed time-series data intersects the base plane, an intersection calculating unit 44 that calculates an intersection point of the line segment and the base plane, a database 45 for recording the intersection point and slope information calculated by the intersection calculating unit 44, a base plane determining unit 46 that determines on the basis of the observed data whether the base plane is appropriate, and a base plane calculating unit 47 that, if the base plane determining unit 46 determines that the base plane is inappropriate, calculates a new base plane.

The set of the intersection determining unit 43 and the intersection calculating unit 44 represents an intersection processing unit, for example. The data reduction apparatus shown in FIG. 16 may further include a data deleting unit that deletes data that is no longer necessary. The data reduction apparatus may further include a data transmitter that transmits intersection points and slope information recorded in the database 45 through a network. The data transmitter may also transmit base plane data.

The data reduction apparatus will be described below in further detail.

Information recorded in the database 45 will be described first.

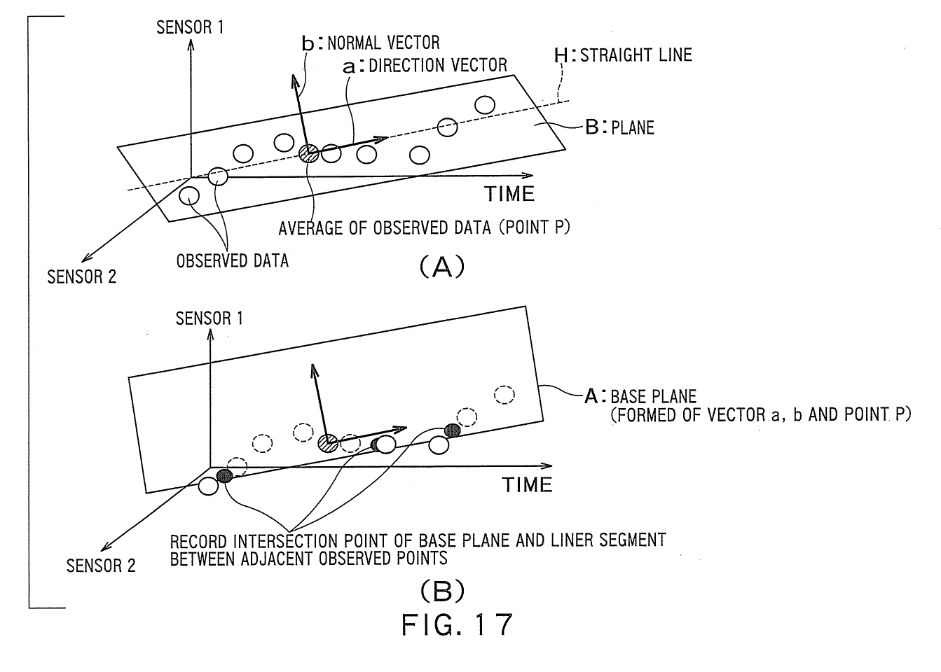

FIG. 17 shows data plotted in a three-dimensional space formed by three axes: two sensors 1 and 2 and a time axis. Data is typically represented by a “curve” in a three-dimensional space. While determination as to whether there is an intersection is made on the basis of a base line or base lines in the first to fourth embodiments, the determination is made on the basis of a base plane in the three-dimensional space. If the line segment connecting two chronologically successive points has a point common with a base plane as a boundary, it is determined that “there is an intersection”.

It has been described that intersection times alone may be recorded in a database instead of intersection points in the first, second, and fourth embodiments. In the fifth embodiment, if only time “T” at which an intersection has occurred were recorded, information that can be restored from “T” and the base plane would be a line, rather than a point, of intersection of a “plane that is perpendicular to an axis “t” and whose intercept with axis “t” is “T” and the base plane, rather than a point. Accordingly, if there are two sensors, not only intersection times but also values from the sensors 1 and 2 at the intersection times need to be recorded. That is, intersection points need to be recorded. The black dots () plotted represent points of intersection with the base plane. These points (value from sensor 1, value from sensor 2, time) are recorded.

How the base plane calculating unit 47 calculates a base plane will be described below.

Suppose there are N pieces of observed data. That is, there are i sets of (tᵢ, x₁(tᵢ), x₂(tᵢ)), where i=1 to N. A plane B that has the smallest square error of the distances to these pieces of data can be obtained by the least-square method. Because there is only one point of observed data at an identical time in the three-dimensional plane, plane B can be expressed as

b₀+t+b₁x₁+b₂x₂=0

where “x₁” represents a value from sensor 1, “x₂” represents a value from sensor 2, and “t” represents time, and “b₀”, “b₁”, and “b₂” are factors. A plane that is orthogonal to plane B may be chosen as the base plane. The normal vector of plane B is orthogonal to plane B. To determine the base plane, two independent vectors parallel to the base plane and one point in a space through which the base plane passes may be given. The base plane may be chosen that passes through the mean value of observed data.

$$\overline{x} = ( \overline{t} , {\overline{x}}_{1} , {\overline{x}}_{2} ) = \frac{1}{N} ( {\sum }_{i = 1}^{N} {t}_{i} , {\sum }_{i = 1}^{N} {x}_{1} ( {t}_{i} ) , {\sum }_{i = 1}^{N} {x}_{2} ( {t}_{i} ) ) \qquad [ Formula 3 ]$$

Another vector for defining the base plane can be obtained using the slope of a straight line H resulting from collinear approximation of observed data. A straight line in the three-dimensional space formed by the two sensors and time axis can be expressed as

$$\frac{t - \overline{t}}{{a}_{1}} = \frac{{x}_{1} - {\overline{x}}_{1}}{{a}_{2}} = \frac{{x}_{2} - {\overline{x}}_{2}}{{a}_{3}} \qquad [ Formula 4 ]$$

Vector (a₁, a₂, a₃) is parallel to the straight line. The equation given above is rewritten as

$$\{ \begin{matrix}t = \frac{{a}_{1}}{{a}_{2}} ( {x}_{1} - {\overline{x}}_{1} ) + \overline{t} \\ t = \frac{{a}_{1}}{{a}_{3}} ( {x}_{2} - {\overline{x}}_{2} ) + \overline{t}\end{matrix} \qquad [ Formula 5 ]$$

From observed data, a₁/a₂ and a₁/a₃ can be obtained by using the least-square method.

The direction of the vector parallel to the straight line can be determined because the ratio among a₁, a₂, and a₃ can be determined from a₁:a₂:a₃=1:a₂/a₁:a₃/a₁. By making the length of the vector to be 1, the vector can be uniquely determined. The unit vector parallel to the straight line thus obtained from observed data is expressed as Q=(q₁, q₂, q₃).

Thus, the unit normal vector of plane B

$$\begin{matrix}p = ( {p}_{1} , {p}_{2} , {p}_{3} ) \\ = ( \frac{1}{\sqrt{{b}_{1}^{2} + {b}_{2}^{2} + 1}} , \frac{{b}_{1}}{\sqrt{{b}_{1}^{2} + {b}_{2}^{2} + 1}} , \frac{{b}_{2}}{\sqrt{{b}_{1}^{2} + {b}_{2}^{2} + 1}} )\end{matrix} \qquad [ Formula 6 ]$$

and the vector q parallel to the straight line and the mean value

x̅ [Formula 7]

can be used to describe point “x” on the base plane with two parameters s₁ and s₂ as

x=\hat{x}+s₁p+s₂q [Formula 8]

This can be rewritten without the parameters as

(p₂q₃−p₃q₂)(t− t̅)−(p₁q₃−p₃q₃)(x₁− x̅₁)−(p₂q₁−p₁q₂)(x₂− x̅₂)=0 [Formula 9]

Determination made by the base plane determining unit 45 as to whether a base plane is appropriate will be described next.

The method described with respect to the second embodiment can be used. An error can be calculated by using plane B on which the base plane is based. The value obtained by substituting observed values into the left-hand side of the equation of plane B “b₀+t+b₁x₁+b₂x₂” is the error between the observed values and plane B.

The process performed by the data reduction apparatus in FIG. 16 is basically equivalent to the processes described with respect to the first to fourth embodiments except that a base plane is used instead of a base line. Therefore, the process according to the fifth embodiment will be apparent from the description of the first to fourth embodiments and hence detailed description is omitted.

### Sixth Embodiment

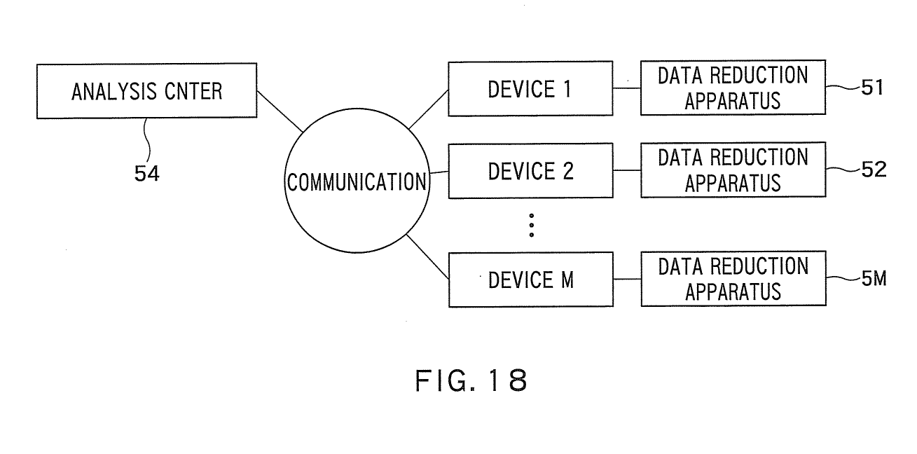

FIG. 18 shows an example in which a data reduction apparatus according to the present invention is applied to remote monitoring of devices. Data observed by sensors provided at remote devices 1 to M are collected and monitored at an analysis center apparatus 54. Data reduction apparatuses 51 to 5M according to the present invention are provided at each of the devices 1 to M. The data reduction apparatuses 51 to 5M reduce the amount of data observed by the sensors. The data reduction apparatuses 51 to 5M transmit reduced data to the analysis center apparatus 54 through the devices 1 to M over a communication network 55.

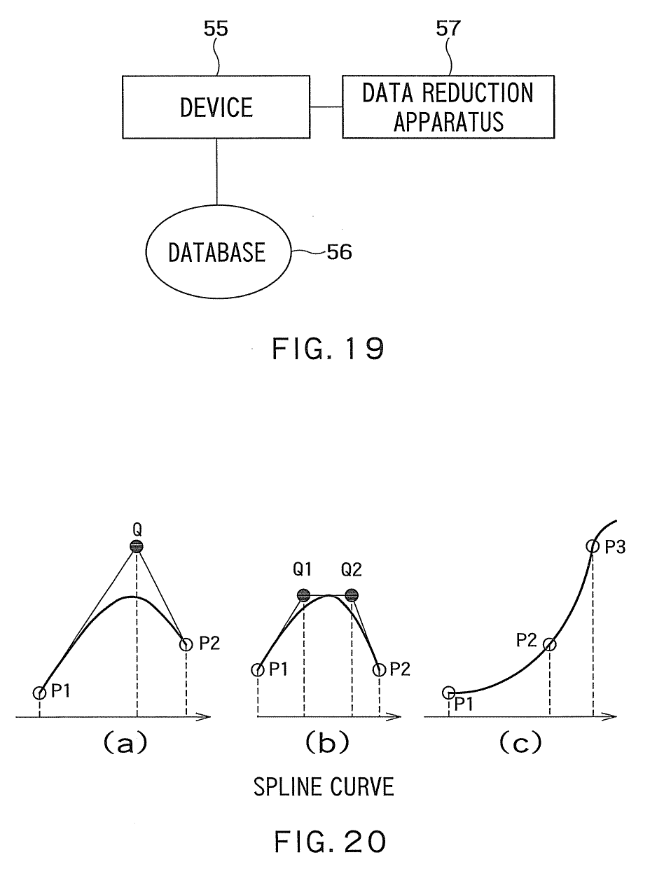

FIG. 19 shows another exemplary application of a data reduction apparatus according to the present invention. The data reduction apparatus 57 according to the present invention reduces the amount of data observed by a sensor provided at a device 55. The reduced data is recorded in a small-capacity database 56 provided in the device 55.

### Seventh Embodiment

In a seventh embodiment, one mode of a method for restoration from data recorded in any of the embodiments will be described. The method will be described with respect to data (points of intersection (or intersection times) with one or more base lines and slope information (slopes or signs)) stored in the first or fourth embodiment by way of example. It will be apparent that restoration from data stored in other embodiment is also possible using the same concept. While slope information is used for restoration in the present embodiment, restoration from intersection points alone (or intersection times and the base line alone) without using slope information is also possible, although more or less restoration precision is sacrificed. The embodiment will be described below in detail.

FIG. 20 shows how smoothly a sequence of given points are connected by a spline curve. Spline curves are detailed in a reference (Les Piegl, On Nurbs: A Survey, IEEE Computer Graphics & Applications, pp. 55-71, January 1991). Many methods for connecting a sequence of points have been proposed. Among those methods, there is a method that connects points by a curve in such a manner that line segments do not lie off the curve.

FIG. 20 (A) shows a curve drawn so as to pass two points P1 and P2 smoothly and not to lie off line segments P1-Q and Q-P2; FIG. 20 (B) shows a curve drawn so as to pass through P1 and P2 but not lie off the three line segments (for a specific drawing method, see the reference given above). In the drawing method, a curve does not pass through intermediate points but does not lie off line segments. That is, if points are positioned in order along the horizontal axis, the curve does not go back along the horizontal axis. Therefore, if the horizontal axis is “time”, a graph in which a curve does not go back in time can be plotted. Even a curve that passes through monotonically increasing (or decreasing) points can be drawn in such a manner the curve does not go back, as shown in FIG. 20 (C). Also, a curve that passes through peak Q in FIG. 20 (A) can be drawn by assuming two points provided by shifting point Q backward and forward along the horizontal axis (see Q1 and Q2 in FIG. 20 (B)).

A restoration method will be described below with respect to a case where the slopes at intersection points are known, a case where only the signs (directions) at intersection points are known, a case where a single base line is provided, and a case where multiple base lines are provided.

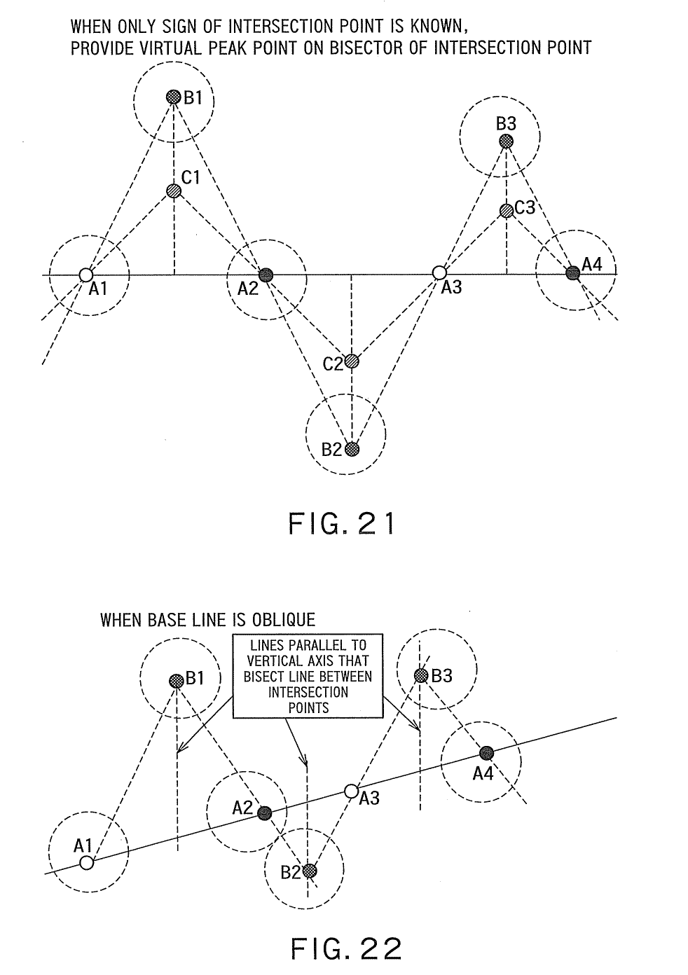

FIG. 21 shows an exemplary restoration method in which one base line is provided and only the sign of slope at an intersection (that is, information indicating that “the base line is crossed from below to above” or “the base line is crossed from above to below”) is known.

Peak points are assumed on the perpendicular bisector of adjacent intersection points and the method of FIG. 20 (A) is used to draw a spline curve that passes through intersection points (A1, A2, A3, and A4), connects the intersection points and the peak, and does not lie off the line segments that connect the peak and the intersection points. Once the height of the first peak (B1 or C1) is determined, the positions of each of the subsequent peaks are determined by the intersection point of an extension of the line between the peak and an intersection point and a bisector and therefore all peaks are uniquely determined. That is, if the first peak is B1, the subsequent peaks are B2, B3; if the first peak is C1, the subsequent peaks are C2, C3. The height of a peak may be determined in such a manner that the largest and smallest among the peaks in the range to be restored are within the region to be drawn.

FIG. 22 shows an exemplary restoration method performed in the case where the base line in FIG. 21 is oblique. In this case, if a perpendicular bisector is drawn to the base line, the peak can lie outside the two intersection points with respect to the horizontal axis. Therefore, a peak is determined by a bisector that is parallel to the vertical axis.

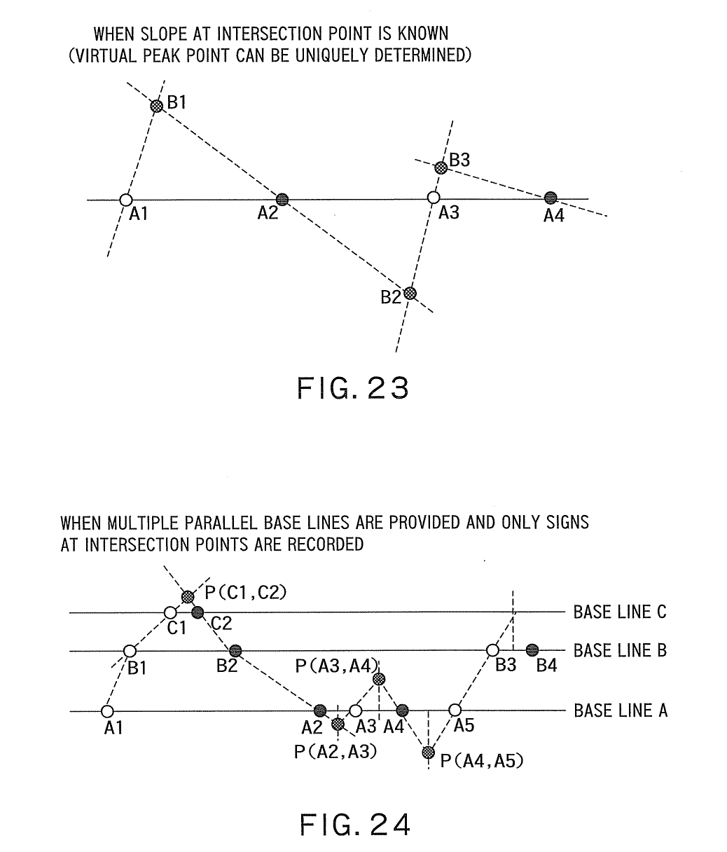

FIG. 23 shows an exemplary restoration method performed in the case where a single base line is provided and the slopes at intersection points are known.

Because a straight line passing through an intersection point can be drawn if the slope at the intersection point is known, the intersection point may be set as a peak. Then, a curve can be drawn by using the method of FIG. 20 (A). A base line that is oblique as shown in FIG. 22 can also be drawn in the same way.

FIG. 24 shows an exemplary restoration method performed in the case where multiple parallel base lines are provided.

If intersection points A1 to A5 on base line A, intersection points B1 to B4 on base line B, and intersection points C1 and C2 on base line C are arranged in order along time axis, it follows that A1, B1, C1, C2, B2, A2, A3, A4, A5, B3, and B4. It can be seen that when two intersection points appear in succession on the same base line, there is a peak between them, except for a point of contact having a slope of 0. In the example shown, there are five peaks in total in C1-C2, A2-A3, A3-A4, A4-A5, and B3-B4.

A peak point may be calculated as follows for example: (i) the peak point is determined from the slopes at intersection points before and after the peak point (for example, if the slopes at C1 and C2 in FIG. 24 are known, the peak point is obtained as shown in FIG. 23), or (ii) an intersection point is determined from the two points before the peak point and the two points after the peak point (for example the intersection point of straight lines B1C1 and C2B2 in FIG. 24 is obtained as the peak point), or (iii) the intersection point of a straight line passing through one of the intersection points and the bisector of the intersection points is determined as the peak point (for example, P(A2, A3) determined in FIG. 24 is the intersection point of straight line B2A2 and the bisector of A2A3).

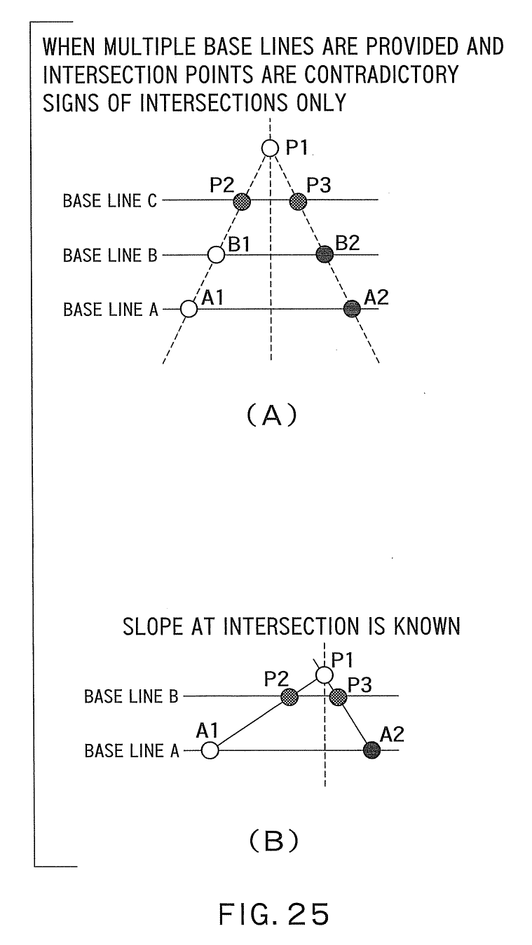

FIG. 25 illustrates an exemplary process for a case where there is a contradiction between a calculated peak point and intersection point information.

In the example in FIG. 25 (A), there are two intersection points A1 and A2 on base line A and B1 and B2 on base line B. Although there are no intersections on base line C, calculation using method (ii) described above yields a peak point, P1, above base line C. In this case, the two intersection points P2 and P3 of straight line A1B1 and base line C and of straight line B2A2 and base line C can be calculated and a curve can be drawn by using the method shown in FIG. 20 (B).

In the example in FIG. 25 (B), intersection points A1 and A2 whose slopes are known are on base line A and the calculated peak point P1 lies outside base line B where there should be no intersection points. Again, a curve can be drawn from points P2 and P3 of intersection with base line B by using the method shown in FIG. 20 (B).

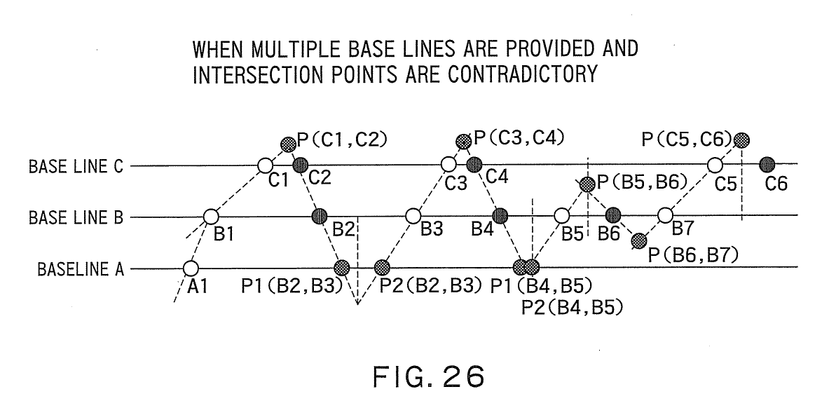

FIG. 26 shows an exemplary procedure for calculating a peak point required for drawing a spline curve from three base lines and intersection points on them.
1. Peak point P (C1, C2) is determined by the intersection point of straight lines B1C1 and C2B2.
2. Because the intersection point of straight lines C2B2 and B3C3 is contradictory to base line A, P1 (B2, B3) and P2 (B2, B3) are determined from a point of intersection with base line A (trapezoid).
3. Peak point P (C3, C4) is determined by the intersection point of straight lines B3C3 and C4B4.
4. Whereas straight line C4B4 is determined, a straight line that passes through intersection point B5 is not determined. Therefore, a peak is determined at the intersection point of the perpendicular bisector of B4 and B5 and straight line C4B4. However, because the peak is contradictory to base line A, P1 (B4, B5) and P2 (B4, B5) are determined by the “trapezoid”.
5. Because a straight line that passes through intersection point B6 is not determined, peak point P (B5, B6) is determined at the intersection point of the bisector of intersection points B5 and B6 and straight line P2 (B4, B5) B5.
6. Peak point P (B6, B7) is determined at the intersection point of straight lines P (B5, B6) B6 and B7C5.
7. Because a straight line that passes through intersection point C6 is not determined, P (C5, C6) is determined at the intersection point of the perpendicular bisector of C5 and C6, and straight line B7C5.

Once the peak points required for drawing a spline curve have been calculated in this way, the spline curve is draw in such a manner that the curve passes through the intersections (A1, B1 to B7, and C1 to C6) and does not lie off line segments (for example P-C1 and P-C2) before and after the calculated peak points (P, P1, and P2), as shown in FIGS. 20A to 20C.

A procedure for restoring a graph using a spline curve from data reduced will be described below.

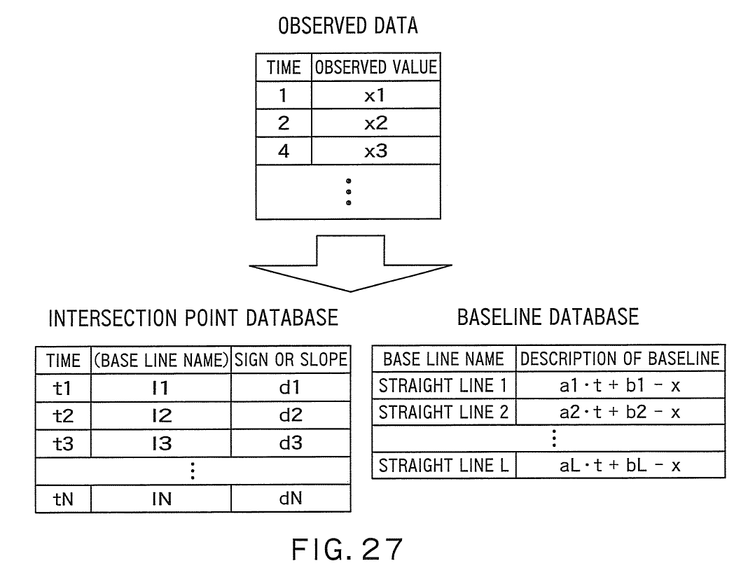

Suppose a database as shown in FIG. 27 is generated by data reduction illustrated with respect to the first or fourth embodiment, for example. The observed data shown is observed values obtained constantly from a sensor together with times. Based on the observed data, time at which an intersection with a base line occurred, a base line name indicating the base line on which an intersection point is, and the slope or sign of the slope at the intersection point are recorded in a intersection point database according to the first or fourth embodiment and a base line database in which base lines are associated with base line names is stored beforehand. If only one base line is provided, the name of the base line does not need to be contained in the intersection point database. It is assumed here that data are placed in chronological order of intersection times in the intersection database.

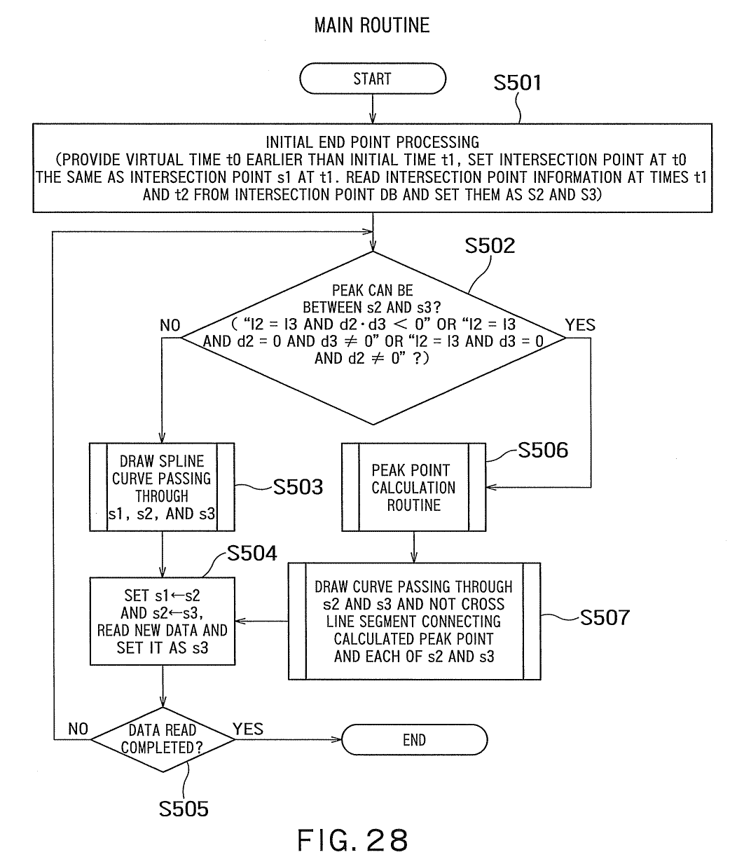

FIG. 28 is a flowchart showing a flow of procedure for restoration based on a database as shown in FIG. 27. The process may be performed by causing a computer to execute a program in which instruction codes are written that instruct the computer to execute the steps shown in the flowchart. A restoring unit that performs processing according to the procedure flow may be provided in the analysis center apparatus in FIG. 18 for example, so that the restoration is performed on the analysis center apparatus.

At S501, initialization (initial end point processing) is performed. More specifically, a virtual time t0 earlier than the initial time t1 is provided and it is assumed that the intersection point at time t0 is the same as the intersection point at time t1, which is set as s1. The intersection points at times t1 and t2 are read from an intersection point database, which are set as s2 and s3.

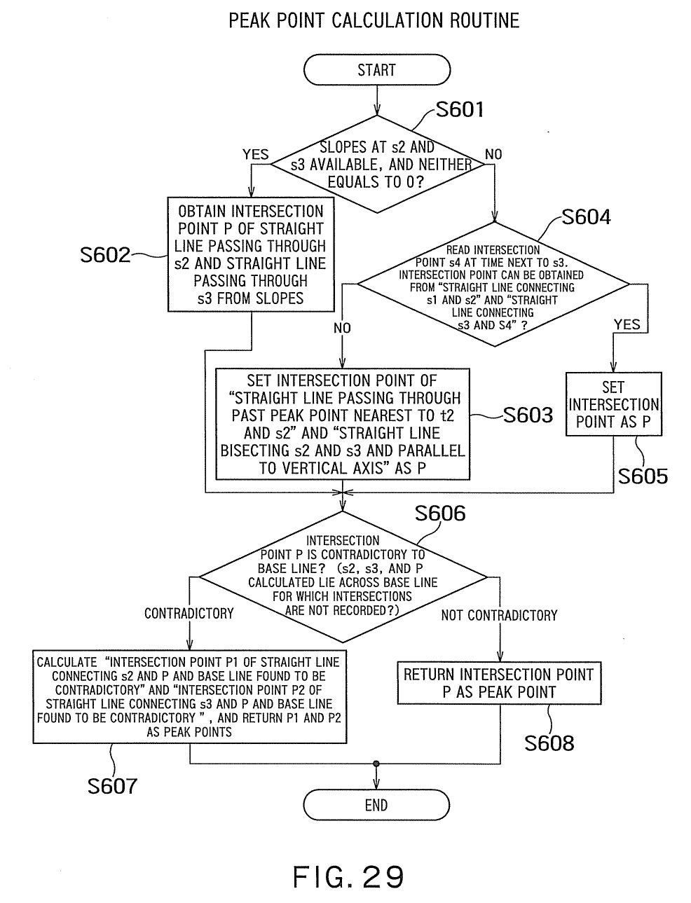

Determination is made as to whether there can be a peak between s2 and s3. Specifically, if “I2=I3 and d2×d3<0” or “I2=I3 and d2=0 and d3≠0” or “I2=I3 and d3=0 and d2≠0” is met, it is determined that there can be a peak. If there can be a peak (YES), a peak point calculation routine shown in the process flow in FIG. 29 is performed (S506) and a curve is drawn that passes through s2 and s3 and does not cross (lie off) the line segments that connect the calculated peak points and s2 and s3 (S507).

If there cannot be a peak (determination at S502 is NO), a spline curve that passes though the three points, s1, s2, and s3 is drawn.

Then, s2 is substituted for s1, s3 is substituted for s2, and a new intersection point is read, which is set as s3 (S504).

When s3 is read at S504, that is, when there is data in the intersection database that is yet to be read (determination at S505 is NO), the process returns to S502; otherwise (determination at S505 is YES), the process will end.

FIG. 29 is a flowchart illustrating a flow of a peak point calculation routine.

Determination is made as to whether the slopes of s2 and s3, neither of which is equal to 0, are stored (S601). If stored, the intersection point P of a straight line passing through s2 and a straight line passing through s3 is calculated from the slopes. If not stored, the intersection point s4 at the time next to s3 is read and determination is made as to whether the intersection point can be obtained from the straight line that connects s1 and s2 and the straight line that connects s3 and s4 (S604). If the intersection point can be obtained, the intersection point is set as P; otherwise, the intersection point of the straight line passing through the past peak point nearest to t2 and s2 and the straight line that bisects s2 and s3 and is parallel to the vertical axis is set as P (S603).

Determination is made as to whether or not the intersection point P is contradictory to a base line (see FIGS. 25 and 26) (S606). If it is not contradictory, intersection P is returned as a peak point. If it is contradictory, the intersection point P1 of the straight line connecting s2 and intersection point P and the base line found to be contradictory, and the interaction point P2 of the straight line connecting s3 with intersection point P and the base line found to be contradictory are calculated and intersection points P1 and P2 are returned as peak points (S607).

What is claimed is:

1. A data recording apparatus comprising:
an observed data storage configured to sequentially store a value observed by a sensor in association with an observed time;
an intersection processing unit
configured to plot each observed value in the observed data storage on a plane coordinate system formed by a time axis and an axis representing a value of the sensor,
configured to determine whether or not a line segment connecting between observed values at adjacent times intersects a base line preset on the plane coordinate system and
configured to calculate an intersection time of the line segment and the base line when the line segment intersects the base line;
an intersection data storage configured to store the intersection time calculated by the intersection processing unit; and
a deleting unit configured to delete observed values subjected to a processing of the intersection processing unit from the observed data storage.

2. The apparatus according to claim 1, further comprising:
a base line determining unit configured to determine whether or not the base line is appropriate; and
a base line calculating unit configured to calculate a new base line to be used instead of the base line, when the base line is not appropriate;
wherein the intersection data storage stores each of the intersection times calculated by the intersection processing unit in association with a base line for which the intersection time is calculated.

3. The apparatus according to claim 2, wherein the base line calculating unit calculates the new base line by using observed values observed at a predetermined number of immediately preceding times.

4. The apparatus according to claim 2, wherein the base line determining unit determines whether or not the base line is appropriate at predetermined time intervals or each time observed values are stored in the observed data storage a predetermined number.

5. The apparatus according to claim 2, wherein the base line determining unit determines whether or not the base line is appropriate on the basis of errors of each observed value for the base line.

6. The apparatus according to claim 1, wherein a plurality of the base lines are preset;
the intersection processing unit calculates a intersection time for each of the base lines; and
the intersection data storage stores each of the intersection times calculated by the intersection processing unit in association with the base line for which the intersection time is calculated.

7. The apparatus according to claim 1, wherein the intersection data storage further stores a slope of the line segment or a sign of the slope in association with the intersection time calculated by the intersection processing unit.

8. A data recording apparatus comprising:
an observed data storage configured to sequentially store a value observed by a sensor in association with an observed time;
a base line/auxiliary line storage configured to store a base line set on a plane coordinate system formed by a time axis and an axis representing a value of the sensor and first and second auxiliary lines provided on opposite sides with respect to the base line along the base line;
an intersection processing unit
configured to plot each observed value in the observed data storage on the plane coordinate system,
configured to determine whether or not a line segment connecting between observed values at adjacent times intersects the first or second auxiliary line, and
configured to specify one of two end points of the line segment, that belongs to a base region formed between the first and second auxiliary lines when the line segment intersects the first or second auxiliary line;
an intersection data storage configured to store the point specified by the intersection processing unit; and
a deleting unit configured to delete observed values subjected to a processing of the intersection processing unit from the observed data storage.

9. The apparatus according to claim 8, wherein the intersection processing unit calculates an intersection time at which the line segment intersects the base line when the line segment passes through the base region and
the data storage stores the intersection time calculated by the intersection processing unit.

10. The apparatus according to claim 8, wherein the intersection data storage further stores a slope of the line segment or a sign of the slope in association with the intersection time calculated by the intersection processing unit.

11. A data recording apparatus, comprising:
an observed data storage configured to sequentially store data including values observed by a plurality of sensors in association with an observed time;
an intersection processing unit
configured to plot each data in the observed data storage on a space coordinate system formed by a time axis and axes representing values of the sensors
configured to determine whether or not a line segment connecting between each data at adjacent times intersects a base plane preset on the space coordinate system and
configured to calculate a intersection point of the line segment and the base plane when the line segment intersects the base plane;
an intersection data storage configured to store an intersection point calculated by the intersection processing unit; and
a deleting unit configured to delete data subjected to a processing of the intersection processing unit from the observed data storage.

12. The apparatus according to claim 11, further comprising:
a base plane determining unit configured to determine whether or not the base plane is appropriate; and
a base plane calculating unit configured to calculate a new base plane to be used instead of the base plane when the base plane is not appropriate.

13. The apparatus according to claim 12, wherein the base plane calculating unit calculates a plane that approximates data at a predetermined number of immediately preceding times and calculates a plane orthogonal to calculated plane as the new base plane.

14. The apparatus according to claim 12, wherein the base plane determining unit determines whether or not the base plane is appropriate at predetermined time intervals or each time the data are stored in the observed data storage a predetermined number.

15. The apparatus according to claim 12, wherein the base plane determining unit determines whether or not the base plane is appropriate on the basis of errors of each data for the base plane.

16. The apparatus according to claim 11, wherein a plurality of the base planes are preset; and
the intersection processing unit calculates an intersection point for each of the base planes.

17. The apparatus according to claim 11, wherein the intersection data storage further stores a slope of the line segment or a sign of the slope in association with the intersection point calculated by the intersection processing unit.

18. A data recording method comprising:
sequentially recording a value observed by a sensor in association with an observed time in an observed data storage;
plotting each observed value in the observed data storage on a plane coordinate system formed by a time axis and an axis representing a value of the sensor,
determining whether or not a line segment connecting between observed values at adjacent times intersects a base line preset on the plane coordinate system and
calculating an intersection time of the line segment and the base line when the line segment intersects the base line;
recording calculated intersection time in intersection data storage; and
deleting observed values subjected to a processing of the determining or the calculating from the observed data storage.

19. The method according to claim 18, further comprising:
setting a second base line identical to the base line on a second plane coordinate system formed by a time axis and an axis representing the sensor,
calculating points on the second base line, corresponding to each intersection time in the intersection data storage and
producing a curve running through calculated points.

20. A data recording method comprising:
sequentially recording a value observed by a sensor in association with an observed time in an observed data storage;
setting a base line on a plane coordinate system formed by a time axis and an axis representing a value of the sensor and first and second auxiliary lines on opposite sides with respect to the base line along the base line;
plotting each observed value in the observed data storage on the plane coordinate system,
determining whether or not a line segment connecting between observed values at adjacent times intersects the first or second auxiliary line, and
specifying one of two end points of the line segment, that belongs to a base region formed between the first and second auxiliary lines when the line segment intersects the first or second auxiliary line;
recording a specified point in an intersection data storage; and
deleting observed values subjected to a processing of the determining or the specifying from the observed data storage.

21. A data recording method, comprising:
sequentially recording data including values observed by a plurality of sensors in association with an observed time in an observed data storage;
plotting each data in the observed data storage on a space coordinate system formed by a time axis and axes representing values of the sensors
determining whether or not a line segment connecting between each data at adjacent times intersects a base plane preset on the space coordinate system and
calculating a intersection point of the line segment and the base plane when the line segment intersects the base plane;
recording a calculated intersection point in an intersection data storage; and
deleting data subjected to a processing of the determining or the calculating from the observed data storage.
